(19) United States
(12) Patent Application Publication
(10) Pub. No.: US 2026/0353289 A1
(43) Pub. Date: Nov. 5, 2026

(54) CARRIER MONITORING METHOD AND DEVICE, STORAGE MEDIUM, AND COMMUNICATION SYSTEM

(71) Applicant: BEIJING XIAOMI MOBILE SOFTWARE CO., LTD., Beijing (CN)

(72) Inventors: Shengxiang GUO, Beijing (CN); Ting FU, Beijing (CN); Yanhua LI, Beijing (CN)

(21) Appl. No.: 19/125,496

(22) PCT Filed: Oct. 31, 2022
(86) PCT No.: PCT/CN2022/128824

§ 371 Date: Apr. 29, 2025

(51) Int. Cl. H04W 52/02; H04W 24/08; H04W 72/231; H04W 76/20

(52) U.S. Cl. CPC H04W 52/0235; H04W 24/08; H04W 52/0274; H04W 72/231; H04W 76/20

(57) ABSTRACT

A carrier monitoring method is performed by a user equipment, and includes: receiving a wake-up signal; and monitoring a target carrier.

### CROSS-REFERENCE TO RELATED APPLICATIONS

The present application is a U.S. National Stage of International Application No. PCT/CN2022/128824, filed on Oct. 31, 2022, the content of which is incorporated by reference herein in its entirety.

### TECHNICAL FIELD

The present disclosure relates to the field of communication technology, and in particular to carrier monitoring method and device, a storage medium, and a communication system.

### BACKGROUND

The introduction of a low-power wake-up signal (WUS) provides a method for enabling a user equipment to adaptively monitor a carrier according to the arrival of a service, so that when a network device has a service need to page the user equipment, the user equipment can send and receive data in a timely manner. The user equipment may transmit data on one or more carriers.

### SUMMARY

According to a first aspect of the embodiments of the present disclosure, there is provided a carrier monitoring method, performed by a user equipment, including:
receiving a wake-up signal; and
monitoring a target carrier.

According to a second aspect of the embodiments of the present disclosure, there is provided a carrier monitoring method, performed by a network device, including:
sending a wake-up signal, where the wake-up signal is configured to trigger a user equipment to wake up a main radio or change a sleep state of the main radio, and monitor a target carrier.

According to a third aspect of the embodiments of the present disclosure, there is provided a carrier monitoring device, including:
a receiving module, configured to receive a wake-up signal; and
a processing module, configured to monitor a target carrier.

According to a fourth aspect of the embodiments of the present disclosure, there is provided a carrier monitoring device, including:
a sending module, configured to send a wake-up signal, where the wake-up signal is configured to trigger a user equipment to wake up a main radio or change a sleep state of the main radio, and monitor a target carrier.

According to a fifth aspect of the embodiments of the present disclosure, there is provided a communication device, including:
a processor; and
a memory for storing processor executable instructions;
where the processor is configured to execute steps of the method according to the first aspect, or steps of the method according to the second aspect.

According to a sixth aspect of the embodiments of the present disclosure, there is provided a non-transitory computer-readable storage medium, on which computer program instructions are stored, wherein when the computer program instructions are executed by a processor, steps of the method according to the first aspect, or steps of the method according to the second aspect are implemented.

According to a seventh aspect of the embodiments of the present disclosure, there is provided a communication system, including:
a user equipment, configured to execute the method according to the first aspect; and
a network device, configured to execute the method according to the second aspect.

### BRIEF DESCRIPTION OF THE DRAWINGS

The drawings herein are incorporated into and constitute a part of the specification, illustrate embodiments consistent with the present disclosure, and are used together with the specification to explain the principles of the present disclosure.

FIG. 1 is a schematic diagram of a communication system according to an example embodiment.

FIG. 2 is a flowchart of a carrier monitoring method according to an example embodiment.

FIG. 3 is a flowchart of a carrier monitoring method according to an example embodiment.

FIG. 4 is a flowchart of a carrier monitoring method according to an example embodiment.

FIG. 5 is a flowchart of a carrier monitoring method according to an example embodiment.

FIG. 6 is a flowchart of a carrier monitoring method according to an example embodiment.

FIG. 7 is a flowchart of a carrier monitoring method according to an example embodiment.

FIG. 8 is a flowchart of a carrier monitoring method according to an example embodiment.

FIG. 9 is a flowchart of a carrier monitoring method according to an example embodiment.

FIG. 10 is a flowchart of a carrier monitoring method according to an example embodiment.

FIG. 11 is a flowchart of a carrier monitoring method according to an example embodiment.

FIG. 12 is a flowchart of a carrier monitoring method according to an example embodiment.

FIG. 13 is a flowchart of a carrier monitoring method according to an example embodiment.

FIG. 14 is a flow chart of a carrier monitoring method according to an example embodiment.

FIG. 15 is a block diagram of a carrier monitoring device according to an example embodiment.

FIG. 16 is a block diagram of a carrier monitoring device according to an example embodiment.

FIG. 17 is a block diagram of a communication device according to an example embodiment.

FIG. 18 is a block diagram of a communication device according to an example embodiment.

### DETAILED DESCRIPTION

The example embodiments will be described in detail herein, and examples thereof are shown in the accompanying drawings. When the following description refers to the drawings, unless otherwise indicated, the same numbers in different drawings represent the same or similar elements. The embodiments described in the following example embodiments do not represent all embodiments consistent with the present disclosure. Instead, they are merely examples of devices and methods consistent with some aspects of the present disclosure as detailed in the appended claims.

In the related art, Rel-18 introduced a low-power WUS, which can be received using a separate receiver, and the user equipment needs to use a main transceiver to process downlink information and uplink information. The user equipment can also use a main receiver to process downlink information, and both the main receiver and the main transceiver can be referred to as a main radio. If the user equipment receives a WUS signal to instruct the user equipment to wake up, the user equipment will turn on the main transceiver for transmitting, receiving and processing downlink/uplink information, or turn on the main receiver for receiving and processing downlink information. If the WUS is not received, or the WUS indicates not to wake up, the user equipment will maintain the sleep state of the main transceiver/main receiver. WUS can be used in RRC (Radio Resource Control) connected state or RRC idle state. In RRC connected state and RRC idle state, in order to keep the user equipment closed for a long time, the receiver receiving WUS needs to complete the synchronization function. The synchronization function can be achieved by monitoring SSB (Synchronization Signal and PBCH block), or WUS itself also has the function of achieving synchronization.

The introduction of low-power WUS signals provides a method for user equipment to adaptively monitor carriers according to the arrival of services, so that when the network device has a service need to page the user equipment, the user equipment can send and receive data in time. The user equipment may transmit data on one or more carriers. For the user equipment, the user equipment does not know which carriers to monitor. If all carriers are monitored, the user equipment will increase a lot of power consumption. If the user equipment monitors the carrier without data transmission, the user equipment will not be able to send and receive data in time, thereby increasing the delay of the user equipment in sending and receiving data.

In addition, the timing of the user equipment monitoring the carrier is also particularly important. Starting to monitor too early will cause the user equipment to increase a lot of power consumption, and starting to monitor too late will cause the user equipment to be unable to send and receive in time. For example, a low-power wake-up signal can be configured to wake up a user equipment or put the user equipment into a shallower sleep state, and the time required for the main radio of the user equipment to wake up from different sleep states is different. For the user equipment to wake up from a shallower sleep state, the time required for waking up the main radio of the user equipment is shorter. If the timing for the user equipment starting to monitor the carrier is late, it may cause the user equipment to delay sending and receiving data. For the user equipment to wake up from a deeper sleep state, the time required for waking up the main radio of the user equipment is longer. If the user equipment starts to monitor the carrier too early, it may cause the user equipment to increase unnecessary power consumption.

In view of this, the embodiment of the present disclosure provides carrier monitoring method and device, a storage medium and a communication system, and the present disclosure is explained in conjunction with the accompanying drawings.

The implementation environment of the embodiment of the present disclosure is first introduced below.

The technical solution of the embodiment of the present disclosure can be applied to various communication systems. The communication system may include one or more of a 4G (the 4th Generation) communication system, a 5G (the 5th Generation) communication system, and other future wireless communication systems (such as 6G). The communication system may also include one or more of a public land mobile network (PLMN) network, a device-to-device (D2D) communication system, a machine-to-machine (M2M) communication system, an Internet of Things (IoT) communication system, a vehicle-to-everything (V2X) communication system or other communication systems.

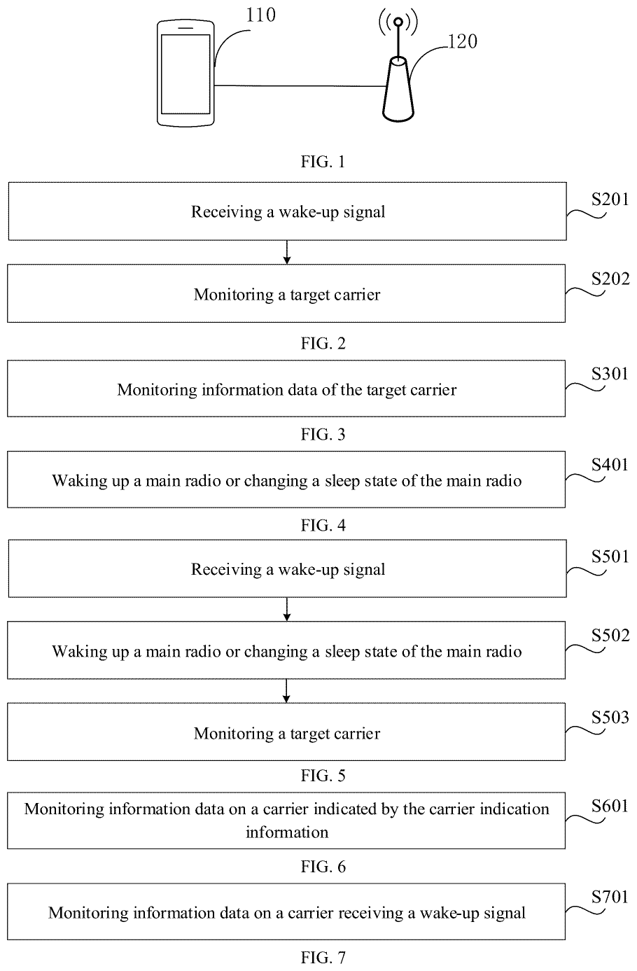

FIG. 1 is a schematic diagram of a communication system according to an example embodiment. As shown in FIG. 1, the communication system may include a user equipment 110 and a network device 120. The communication system may be configured to support 4G network access technology, such as Long Term Evolution (LTE) access technology, or 5G network access technology, such as New Radio Access Technology (New RAT), or other future wireless communication technologies. It should be noted that in the communication system, the number of user equipment and network devices may be one or more, and the number of user equipment and network devices of the communication system shown in FIG. 1 is only an adaptive example, and the present disclosure does not limit this.

The network device 120 in FIG. 1 can be configured to support access and communication of user equipment. For example, the network device can be an evolutional Node B (eNB or eNodeB) in LTE. The network device can also be the next Generation Node B, gNB or gNodeB) in a 5G network. The network device can also be a wireless access network (NG Radio Access Network, NG-RAN) device in a 5G network. The network device can also be a base station, a broadband network gateway (BNG), an aggregation switch or a non-3GPP (3rd Generation Partnership Project) access device in a future evolved public land mobile network (PLMN), etc. In some embodiments, the network device in the embodiment of the present disclosure may include various forms of base stations, such as: a macro base station, a micro base station (also known as a small station), a relay station, an access point, a 5G base station or a future base station, a satellite, a transmission point (Transmitting and Receiving Point, TRP), a transmitting point (TP), a mobile switching center, and a device to device (D2D), a machine to machine (M2M), Internet of Things (IoT), a vehicle-to-everything (V2X) or other devices that assume the function of base stations in communications, etc., which are not specifically limited in the embodiment of the present disclosure. For the convenience of description, in all embodiments of the present disclosure, the devices that provide wireless communication functions for the terminal device are collectively referred to as network devices or base stations.

The user equipment 110 in FIG. 1 can be an electronic device that provides voice or data connectivity. For example, the terminal device can also be called a subscriber unit, a mobile station, a station, a terminal, etc. For example, the user equipment may include a smart phone, a smart wearable device, a smart speaker, a smart tablet, a wireless modem, a wireless local loop (WLL) station, a PDA (Personal Digital Assistant), a CPE (Customer Premise Equipment), etc. With the development of wireless communication technology, devices that can access a communication system, can communicate with network devices of a communication system, can communicate with other objects through a communication system, or can directly communicate between two or more devices can all be user equipment in the embodiments of the present disclosure. For example, terminals and cars in smart transportation, household devices in smart homes, power meter reading instruments in smart grids, voltage monitoring instruments, environmental monitoring instruments, video monitoring instruments in smart security networks, cash registers, etc. In the embodiments of the present disclosure, the user equipment can communicate with network device. Multiple user equipment can also communicate with each other. The user equipment can be static or mobile, and the present disclosure does not limit this.

In FIG. 1, the network device 120 is configured to send a wake-up signal, and the user equipment 110 is configured to receive a wake-up signal and monitor a target carrier. The implementation process of the network device 120 sending the wake-up signal, the implementation process of the user equipment 110 receiving the wake-up signal, and the implementation process of the user equipment 110 monitoring the target carrier can refer to the following related embodiments, and this embodiment is not repeated here.

FIG. 2 is a flowchart of a carrier monitoring method according to an example embodiment. The carrier monitoring method can be performed by a user equipment in the above communication system. Referring to FIG. 2, the carrier monitoring method may include:

S201, receiving a wake-up signal.

S202, monitoring a target carrier.

In some embodiments, the wake-up signal may be LP WUS (Low Power Wakeup Signal).

In some embodiments, the network device may directly send a wake-up signal to the user equipment, and the network device may also forward the wake-up signal to the user equipment through a forwarding device.

The target carrier is a carrier for data transmission between the user equipment and the network device. For example, the carrier may be called a cell.

Through the above scheme, the wake-up signal is received and the target carrier is monitored, thereby realizing monitoring of a specific carrier, ensuring that the user equipment can send and receive data in a timely manner and avoiding unnecessary power consumption, and thus reducing the delay and power consumption of the user equipment in sending and receiving data.

FIG. 3 is a flowchart of a carrier monitoring method shown according to an example embodiment. The carrier monitoring method can be performed by the user equipment in the above communication system. Referring to FIG. 3, the above step of monitoring the target carrier may include:

S301, monitoring information data of the target carrier.

The information data is the data transmitted between the user equipment and the network device, and the service between the user equipment and the network device is realized through the transmitted data.

Through the above manner, the information data of the target carrier is monitored, so that the user equipment can monitor the corresponding information data in time, ensuring that the user equipment can send and receive data in time, and realizing timely communication between the user equipment and the network device.

FIG. 4 is a flowchart of a carrier monitoring method shown according to an example embodiment. The carrier monitoring method can be executed by the user equipment in the above communication system. Referring to FIG. 4, the carrier monitoring method may further include:

S401, waking up a main radio or changing a sleep state of the main radio.

In some embodiments, after receiving the wake-up signal, the user equipment may wake up the main radio or change the sleep state of the main radio. That is, the wake-up signal is configured to wake up the main radio or change the sleep state of the main radio.

In some embodiments, the main radio may include a main receiver. The main receiver being awakened may be understood as the main receiver being able to receive downlink information. The downlink information here may be, for example, downlink control information and downlink data information.

In some embodiments, the main radio may include a main transceiver. The main transceiver being awakened may be understood as the main transceiver being able to send uplink information and receive downlink information. The uplink information here may be, for example, uplink control information and uplink data information, and the downlink information here may be, for example, downlink control information and downlink data information.

In some embodiments, the main radio may include a main receiver and a main transceiver. The explanation of the main receiver and the main transceiver may refer to the above-mentioned related embodiments, and it will not be repeated here in this embodiment.

In some embodiments, the sleep state may be, for example, at least one of an ultra-deep sleep state, a deep sleep state, a light sleep state, a micro sleep state, and a super-micro sleep state, and the sleep levels of the ultra-deep sleep state, the deep sleep state, the light sleep state, the micro sleep state, and the super-micro sleep state decrease in sequence. The change of sleep state may be caused by a step-by-step decrease in sleep level, where the step-by-step decrease may be understood as the sleep levels of the sleep states before and after the change are adjacent and the sleep level after the change is lower than the sleep level before the change, for example, from a deep sleep state to a light sleep state, or for example, from a micro sleep state to a super-micro sleep state, etc. The change of sleep state may be caused by a skip-level decrease in sleep level, where the skip-level decrease may be understood as the sleep levels of the sleep states before and after the change are non-adjacent and the sleep level after the change is lower than the sleep level before the change, for example, from a deep sleep state to a micro sleep state, or for example, from a light sleep state to a super-micro sleep state, etc.

It is worth noting that when the user equipment has no data to transmit, the wake-up signal may be configured to notify the user equipment not to wake up, so as to reduce the power consumption of the user equipment. When the user equipment has data to transmit, the wake-up signal may be configured to notify the user equipment to wake up or change the sleep state. Waking up the main radio here means waking up the user equipment, and changing the sleep state of the main radio here means changing the sleep state of the user equipment.

Through the above scheme, the wake-up signal is configured to wake up the main radio so that the user equipment can send and receive information data. The wake-up signal is configured to change the sleep state of the main radio so that the user equipment is in a lighter sleep state, reducing the time required for waking up the main radio later, thereby reducing the delay of the user equipment in transmitting and receiving data.

FIG. 5 is a flowchart of a carrier monitoring method according to an example embodiment. The carrier monitoring method can be performed by the user equipment in the above communication system. Referring to FIG. 5, the carrier monitoring method may include:

S501, receiving a wake-up signal.

S502, waking up a main radio or changing a sleep state of the main radio.

S503, monitoring a target carrier.

The implementation process of S501, S502 and S503 can refer to the above-mentioned related embodiments, and it will not be repeated here in this embodiment. In addition, this embodiment does not limit the implementation order of S502 and S503, and S503 can also be performed first, and then S502.

Through the above scheme, the wake-up signal is configured to wake up the main radio so that the user equipment can transmit and receive information data, or the wake-up signal is configured to change the sleep state of the main radio so that the user equipment is in a lighter sleep state, reducing the time of being awakened, thereby reducing the delay of the user equipment in transmitting and receiving data.

FIG. 6 is a flowchart of a carrier monitoring method according to an example embodiment. The carrier monitoring method can be performed by the user equipment in the above communication system. Referring to FIG. 6, the above step of monitoring the target carrier may include:

S601, monitoring information data on a carrier indicated by the carrier indication information.

The wake-up signal may include carrier indication information, and the carrier indication information indicates the target carrier for the user equipment to monitor the information data.

The explanation of the wake-up signal and the information data here can refer to the above related embodiments, and it is not repeated here in this embodiment.

Through the above scheme, monitoring the information data on the carrier indicated in the carrier indication information of the wake-up signal can avoid the problem of the user equipment monitoring other redundant carriers to increase a lot of power consumption. In addition, the carrier indication information can be configured to achieve flexible setting of the target carrier, thereby improving the flexibility of carrier monitoring.

FIG. 7 is a flowchart of a carrier monitoring method according to an example embodiment. The carrier monitoring method can be performed by the user equipment in the above communication system. Referring to FIG. 7, the above step of monitoring the target carrier may include:

S701, monitoring information data on a carrier receiving a wake-up signal.

The explanation of the wake-up signal and the information data here can refer to the above-mentioned related embodiments, and it is not repeated here in this embodiment.

It is worth noting that the user equipment has a higher probability of successfully receiving the information data on the carrier receiving the wake-up signal.

In this way, the information data is monitored on the carrier receiving the wake-up signal, and thus the probability of successfully and timely receiving the information data is higher, thereby further reducing the delay of the user equipment in sending and receiving data.

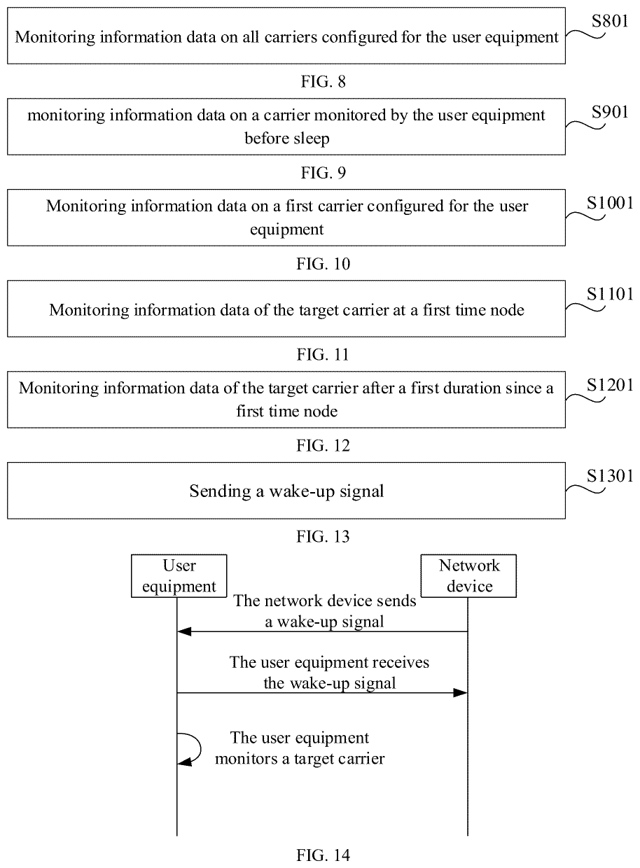

FIG. 8 is a flowchart of a carrier monitoring method according to an example embodiment. The carrier monitoring method can be performed by the user equipment in the above communication system. Referring to FIG. 8, the above step of monitoring the target carrier includes:

S801, monitoring information data on all carriers configured for the user equipment.

The explanation of the information data here can refer to the above-mentioned related embodiments, and it is not repeated here in this embodiment.

It is worth noting that the user equipment generally has a higher probability of successfully transmitting and receiving data on the configured carrier.

In this way, the information data is monitored on all carriers configured for the user equipment, and thus the probability of successfully and timely receiving information data is higher, thereby further reducing the delay of the user equipment in sending and receiving data.

FIG. 9 is a flowchart of a carrier monitoring method according to an example embodiment. The carrier monitoring method can be performed by the user equipment in the above communication system. Referring to FIG. 9, the above step of monitoring the target carrier may include:

S901, monitoring information data on a carrier monitored by the user equipment before sleep.

The explanation of the information data here can refer to the above related embodiments, and it is not repeated here in this embodiment.

It is worth noting that the carrier monitored by the user equipment before sleep is generally the carrier on which the user equipment successfully and timely receives information data.

In this way, the information data is monitored on the carrier monitored by the user equipment before sleep, and thus the probability of successfully and timely receiving information data is higher, thereby further reducing the delay of the user equipment in sending and receiving data.

FIG. 10 is a flowchart of a carrier monitoring method according to an example embodiment. The carrier monitoring method can be performed by the user equipment in the above communication system. Referring to FIG. 10, the above step of monitoring the target carrier may include:

S1001, monitoring information data on a first carrier configured for the user equipment.

The first carrier may be one or more of an anchor carrier, a primary cell carrier, and a primary secondary cell carrier.

For the frequency division duplex system (FDD), the anchor carrier refers to the carrier that the UE considers to transmit the NB-IoT-related physical broadcast channel (NPBCH), primary synchronization signal (NPSS)/secondary synchronization signal (NSSS), system information block (SIB-NB), etc. The primary cell carrier is a carrier that carries signaling and can manage other carriers. The primary secondary cell carrier is configured to extend the bandwidth enhancement rate and can be managed by the primary cell carrier, and the management here can be addition and/or deletion.

Through the above scheme, the probability of successfully and timely receiving the information data on the first carrier configured by the user equipment is higher, thereby further reducing the delay of the user equipment in sending and receiving data.

In some embodiments, the carrier indication information may include at least one carrier indication field, and the decimal value of the carrier indication field corresponds to a carrier index. The carrier indication field can be represented by 2 or 3 bits of data, and the decimal value of each carrier indication field corresponds to a carrier index. Through the carrier index, the corresponding carrier can be queried, so that the user equipment can monitor information data on the carrier corresponding to the carrier index.

In some embodiments, the carrier indication information may include an index of a carrier combination. In other embodiments, the carrier indication information may include a carrier index, where the physical meanings represented by the carrier index and the index here are consistent. The corresponding carrier can be queried through the carrier index or index, and both the carrier index and the index can be represented by a decimal value. Refer to the corresponding relationship between carrier index/index and carrier shown in the following table:

| Carrier | Carrier |
|---|---|
| index/Index | combination |
| 0 | CC0 |
| 1 | CC1 |
| 2 | CC2 |
| 3 | CC3 |
| 4 | CC0, CC1 |
| 5 | CC0, CC2 |
| 6 | CC0, CC3 |
| 7 | CC1, CC2 |
| 8 | CC1, CC3 |
| 9 | CC2, CC3 |
| 10 | CC0, CC1, CC2 |
| 11 | CC0, CC1, CC3 |
| 12 | CC0, CC2, CC3 |
| 13 | CC1, CC2, CC3 |
| 14 | CC0, CC1, CC2, CC3 |
| 15 | Reserved |

In the above table, for carrier index 0, the corresponding carrier is a single carrier (CC0). For index 10, the corresponding carrier is a combination of carriers, that is, multiple carriers (CC0, CC1 and CC2). Other carriers for representation are reserved. The carrier combination in the above table can be understood as including at least one carrier.

In some embodiments, the carrier indication information may include at least one carrier identification. Each carrier identification uniquely corresponds to a carrier, and through the carrier identification, the user equipment can monitor information data on the carrier corresponding to the carrier identification.

In some embodiments, the carrier indication information may include at least one of at least one carrier indication field, an index of a carrier combination, a carrier index, and at least one carrier identification. The specific implementation of this embodiment can refer to the above-mentioned related embodiments, and it is not repeated here in this embodiment.

In some embodiments, the first carrier can be configured by at least one of the following signaling:
a downlink control information (DCI) signaling;
a media access control (MAC) signaling;
a media access control control element (MAC CE) signaling; and
a radio resource control (RRC) signaling.

The explanation of downlink control information signaling, media access control signaling, media access control control element signaling and radio resource control signaling can refer to the relevant technology, and it is not repeated here in this embodiment.

FIG. 11 is a flowchart of a carrier monitoring method according to an example embodiment. The carrier monitoring method can be performed by the user equipment in the above communication system. Referring to FIG. 11, the above step of monitoring the target carrier may include:

S1101, monitoring information data of a target carrier at a first time node.

The explanation of the information data here can refer to the above-mentioned related embodiments, and it is not repeated here in this embodiment.

In some embodiments, the target carrier may be the carrier indicated by the carrier indication information. The explanation of the carrier indication information can refer to the above-mentioned related embodiments, and it is not repeated here in this embodiment.

In other embodiments, the target carrier may be the carrier receiving the wake-up signal. The explanation of the carrier receiving the wake-up signal can refer to the above-mentioned related embodiments, and it is not repeated here in this embodiment.

In other embodiments, the target carrier may be all carriers configured for the user equipment. The explanation of all carriers configured for the user equipment can refer to the above-mentioned related embodiments, and it is not repeated here in this embodiment.

In other embodiments, the target carrier may be the carrier monitored by the user equipment before sleep. The explanation of the carrier monitored by the user equipment before sleep can refer to the above-mentioned related embodiments, and it is not repeated here in this embodiment.

In other embodiments, the target carrier may be the first carrier configured by the user equipment. The explanation of the first carrier may refer to the above-mentioned related embodiments, and it will not be repeated here in this embodiment.

As can be seen from the foregoing, the timing of the user equipment monitoring the carrier is also particularly important. Starting monitoring too early will cause the user equipment to increase a lot of power consumption, and starting monitoring too late will cause the user equipment to be unable to send and receive in time.

Therefore, through the above scheme, the first time node can be flexibly set, and the information data of the target carrier can be monitored at the first time node, so as to realize the flexible configuration of the time for the user equipment to monitor the carrier, thereby avoiding the situation that starting monitoring too early will cause the user equipment to increase a lot of power consumption and starting monitoring too late will cause the user equipment to be unable to send and receive in time.

FIG. 12 is a flowchart of a carrier monitoring method according to an example embodiment. The carrier monitoring method can be performed by the user equipment in the above communication system. Referring to FIG. 12, the above step of monitoring the target carrier may include:

S1201, monitoring information data of the target carrier after a first duration since a first time node.

The explanation of the information data here can refer to the above-mentioned related embodiments, and it is not repeated here in this embodiment.

In some embodiments, the target carrier may be a carrier indicated by the carrier indication information. The explanation of the carrier indication information can refer to the above-mentioned related embodiments, and it is not repeated here in this embodiment.

In other embodiments, the target carrier may be a carrier that receives a wake-up signal. The explanation of the carrier that receives the wake-up signal can refer to the above-mentioned related embodiments, and it is not repeated here in this embodiment.

In other embodiments, the target carrier may be all carriers configured for the user equipment. The explanation of all carriers configured for the user equipment can refer to the above-mentioned related embodiments, and it is not repeated here in this embodiment.

In other embodiments, the target carrier may be a carrier monitored by the user equipment before sleep. The explanation of the carrier monitored by the user equipment before sleep can refer to the above-mentioned related embodiments, and it is not repeated here in this embodiment.

In other embodiments, the target carrier may be the first carrier configured by the user equipment. The explanation of the first carrier may refer to the above-mentioned related embodiments, and it is not repeated here in this embodiment.

Through the above scheme, the first time node and the first duration can be flexibly set, and the information data of the target carrier can be monitored after the first duration since the first time node, so as to realize the flexible configuration of the time for the user equipment to monitor the carrier, thereby avoiding the situation that starting monitoring too early will cause the user equipment to increase a lot of power consumption and starting monitoring too late will cause the user equipment to be unable to send and receive in time.

In some embodiments, the first time node may be the time node when the user equipment receives the wake-up signal.

The explanation of the wake-up signal may refer to the above-mentioned related embodiments, and it is not repeated here in this embodiment.

As can be seen from the foregoing, for the user equipment in a lighter sleep state, the wake-up time is short, for example, from a micro sleep state to a super-micro sleep state, so the target carrier can be monitored at the time node when the user equipment receives the wake-up signal.

In this way, it can be ensured that the user equipment can enter the monitoring of the target carrier in time, and the delay of the user equipment in sending and receiving data can be reduced.

In some embodiments, the first time node can be a time node when the user equipment successfully decodes the received wake-up signal.

As can be seen from the foregoing, the time for waking up in different sleep levels is different. For some sleep states in a medium sleep level, the target carrier can be monitored at a time node when the user equipment successfully decodes the received wake-up signal.

In this way, it can be ensured that the user equipment can enter the monitoring of the target carrier in time and the power consumption caused by the user equipment monitoring too early can be avoided.

In some embodiments, the first time node can be a time node when the main radio is awakened.

The explanation of the main radio can refer to the above-mentioned related embodiments, and it is not repeated here in this embodiment.

As can be seen from the foregoing, for the user equipment in a lighter sleep level, the time for waking up is very short, such as waking up from a super-micro sleep state, so the target carrier can be monitored at the time node when the main radio is awakened.

In this way, the power consumption of the user equipment can be reduced.

In some embodiments, the first time node can be a time node when the sleep state of the main radio changes.

The explanation of the main radio can refer to the above-mentioned related embodiments, and it is not repeated here in this embodiment.

As can be seen from the foregoing, the time required for the main radio of the user equipment to wake up from different sleep states is different. And it is worth noting that the time required for the user equipment to wake up from a lighter sleep state is less than the time required for the user equipment to wake up from a deeper sleep state.

Therefore, in order to solve the problem of delay in data transmission and reception of the user equipment caused by the user equipment waking up from a lighter sleep state and the user equipment starting to monitor the carrier at a late time, the target carrier can be monitored from the time node when the sleep state of the main radio changes, thereby reducing the delay in the user equipment receiving and sending data.

In some embodiments, the first time node can be one or more of the time node when the user equipment receives the wake-up signal, the time node when the user equipment successfully decodes the received wake-up signal, the time node when the main radio is awakened, and the time node when the sleep state of the main radio changes.

In some embodiments, the first duration in the above-mentioned related embodiments can be configured by the network device to the user equipment.

In some embodiments, the first duration in the above-mentioned related embodiments can be predefined in the protocol.

In some embodiments, the first duration in the above-mentioned related embodiments may be set by the user equipment and reported to the network device.

In some embodiments, the information data in the above-mentioned related embodiments may be downlink control information.

The downlink control information refers to downlink information sent by the network device to the terminal. The downlink control information may be transmitted using a downlink channel, where the downlink channel is, for example, a physical downlink control channel (PDCCH).

In some embodiments, the information data in the above-mentioned related embodiments may be downlink data information.

The downlink data information refers to downlink information sent by the network device to the terminal. The downlink data information may also be transmitted using a downlink channel, where the downlink channel may be, for example, a physical downlink shared channel (PDSCH).

In some embodiments, the information data in the above-mentioned related embodiments may be uplink control information.

The uplink control information refers to uplink information sent by the user equipment to the network device. The uplink control information may be transmitted using an uplink channel, where the uplink channel may be, for example, a physical uplink control channel (PUCCH).

In some embodiments, the information data in the above-mentioned related embodiments may be uplink data information.

The uplink data information refers to the uplink information sent by the user equipment to the network device. The uplink data information can also be transmitted using the uplink channel, and the uplink channel here can be, for example, a physical uplink shared channel (PUSCH).

In some embodiments, the information data in the above-mentioned related embodiments can be a wake-up signal. The explanation of the wake-up signal can refer to the above-mentioned related embodiments, and it is not repeated here in this embodiment.

In some embodiments, the information data in the above-mentioned related embodiments can be at least one of downlink control information, downlink data information, uplink control information, uplink data information and wake-up signal. The information data in this embodiment can refer to the above-mentioned related embodiments, and it is not repeated here in this embodiment.

In some embodiments, the terminal receives WUS sent by the base station, and the WUS is configured to wake up at least one main receiver or change the sleep state of the main receiver. The terminal here is such as the above-mentioned user equipment, and the base station here is such as the above-mentioned network device. In addition, the main receiver, sleep state, etc. can refer to the above-mentioned related embodiments, and it is not repeated here in this embodiment.

In some embodiments, the terminal can monitor the downlink control information of at least one cell/carrier after the first time node. The terminal here is, for example, the user equipment mentioned above, and the cell/carrier here is, for example, the target carrier mentioned above. In addition, the first time node, the downlink control information, etc. can refer to the above-mentioned related embodiments.

In some embodiments, WUS carries cell/carrier indication information, and the cell/carrier indication information indicates at least one cell/carrier. The cell/carrier indication information here is, for example, the carrier indication information mentioned above, and the cell/carrier is, for example, the target carrier mentioned above.

In some embodiments, the terminal monitors the downlink control information on the carrier receiving the LP WUS. The terminal here is, for example, the user equipment mentioned above, and the LP WUS is, for example, the low-power wake-up signal mentioned above.

In some embodiments, the terminal monitors the carrier that the main receiver monitors before sleeping. The terminal here is, for example, the user equipment mentioned above.

In some embodiments, the terminal monitors downlink control information on the first carrier. The terminal here is, for example, the user equipment mentioned above. The explanation of the first carrier can refer to the above embodiment, and it is not repeated here in this embodiment.

In some embodiments, the terminal monitors downlink control information on all configured carriers. The terminal here is, for example, the user equipment mentioned above.

In some embodiments, the cell indication information includes but is not limited to at least one carrier indication field, or an index of a cell combination, or a cell index, or at least one cell ID. The cell indication information here is, for example, the carrier indication information mentioned above, the cell combination here is, for example, the carrier combination mentioned above, the cell index here is, for example, the carrier index mentioned above, and the cell ID here is, for example, the carrier identification mentioned above.

In some embodiments, the first carrier includes, but is not limited to, the configured anchor carrier, the primary cell carrier, and the secondary cell carrier. The explanation of the anchor carrier, the primary cell carrier, and the secondary cell carrier can refer to the above related embodiments, and it is not repeated here in this embodiment.

In some embodiments, the terminal monitors downlink control information according to the cell indication information carried by the LP WUS. The terminal here is for example the user equipment mentioned above, the LP WUS here is for example the low-power wake-up signal mentioned above, and the cell indication information here is for example the carrier indication information mentioned above.

In some embodiments, the way to configure the first carrier includes but is not limited to DCI, MAC, MAC CE, RRC, etc. The explanation about the first carrier can refer to the above embodiment, and it is not repeated here in this embodiment.

In some embodiments, the first time node includes but is not limited to: the time node when the terminal successfully decodes the LP WUS, the time node when the terminal receives the LP WUS, the time node when the main receiver is awakened, after the first duration since the time node when the terminal successfully decodes the LP WUS, after the first duration since the time node when the terminal receives the LP WUS, and after the first duration since the time node when the main receiver is awakened. The terminal here is for example the user equipment mentioned above, and the LP WUS here is for example the low-power wake-up signal mentioned above.

In some embodiments, the first duration is reported by the terminal, configured by the base station, or predefined by the protocol, etc. The terminal here is for example the user equipment mentioned above, and the base station here is for example the network device mentioned above.

FIG. 13 is a flowchart of a carrier monitoring method according to an example embodiment. The carrier monitoring method can be performed by the network device in the above communication system. Referring to FIG. 13, the carrier monitoring method may include:

S1301, sending a wake-up signal.

The wake-up signal is configured to trigger the user equipment to wake up the main radio or change the sleep state of the main radio, and monitor the target carrier.

The explanation of the main radio and the wake-up signal can refer to the above-mentioned related embodiments, and it is not limited here in this embodiment.

Through the above scheme, after receiving the wake-up signal, the user equipment can monitor the target carrier to monitor the specific carrier, thereby ensuring that the user equipment can send and receive data in time and avoiding unnecessary power consumption, and thus the delay and power consumption of the user equipment in sending and receiving data is reduced. In addition, after receiving the wake-up signal, the user equipment can wake up the main radio so that the user equipment can send and receive information data in time, or change the sleep state of the main radio to reduce the wake-up time of the user equipment.

In some embodiments, the wake-up signal includes carrier indication information, and the carrier indication information indicates the target carrier for the user equipment to monitor the information data.

Through the above scheme, the problem of the user equipment increasing a lot of power consumption by monitoring other redundant carriers can be avoided by monitoring the information data on the carrier indicated in the carrier indication information of the wake-up signal. In addition, the carrier indication information can be used to realize the flexible setting of the target carrier, thereby improving the flexibility of carrier monitoring.

In some embodiments, the wake-up signal is configured to trigger the user equipment to monitor the information data of the target carrier at the first time node. The implementation process of the user equipment monitoring the information data of the target carrier at the first time node can refer to the above-mentioned related embodiments, and it is not repeated here in this embodiment.

Through the above scheme, the first time node can be flexibly set, and the information data of the target carrier can be monitored at the first time node, so as to realize the flexible configuration of the time for the user equipment to monitor the carrier, thereby avoiding the situation that starting monitoring too early will cause the user equipment to increase a lot of power consumption and starting monitoring too late will cause the user equipment to be unable to send and receive in time.

In some embodiments, the wake-up signal is configured to trigger the user equipment to monitor the information data of the target carrier after the first duration since the first time node. The implementation process of the user equipment monitoring the information data of the target carrier at the first time node can refer to the above-mentioned related embodiments, and it is not repeated here in this embodiment.

Through the above scheme, the first time node and the first duration can be flexibly set, and the information data of the target carrier can be monitored after the first duration since the first time node, so as to realize the flexible configuration of the time for the user equipment to monitor the carrier, thereby avoiding the situation that starting monitoring too early will cause the user equipment to increase a lot of power consumption and starting monitoring too late will cause the user equipment to be unable to send and receive in time.

In some embodiments, the wake-up signal is configured to trigger the user equipment to monitor the information data of the carrier that receives the wake-up signal. The implementation process of the user equipment monitoring the information data of the carrier that receives the wake-up signal can refer to the above-mentioned related embodiments, and it is not repeated here in this embodiment.

Through the above scheme, the information data is monitored on the carrier that receives the wake-up signal, and the probability of successfully and timely receiving the information data is higher, thereby further reducing the delay of the user equipment in sending and receiving data.

In some embodiments, the wake-up signal is configured to trigger the user equipment to monitor the information data of all carriers configured to the user equipment. The implementation process of the user equipment monitoring the information data on all carriers configured to the user equipment can refer to the above-mentioned related embodiments, and it is not repeated here in this embodiment.

Through the above scheme, the information data is monitored on all carrier configured for the user equipment, and the probability of successfully and timely receiving information data is higher, thereby further reducing the delay of the user equipment in sending and receiving data.

In some embodiments, the wake-up signal is configured to trigger the user equipment to monitor the information data of the first carrier. The implementation process of the user equipment monitoring the information data of the first carrier can refer to the above-mentioned related embodiments, and it is not limited here in this embodiment.

Through the above scheme, the information data is monitored on the first carrier configured for the user equipment, and the probability of successfully and timely receiving information data is higher, thereby further reducing the delay of the user equipment in sending and receiving data.

In some embodiments, the first carrier is one or more of the anchor carrier, the primary cell carrier, and the primary secondary cell carrier. The explanation of the anchor carrier, the primary cell carrier, and the primary secondary cell carrier can refer to the above-mentioned related embodiments, and it is not repeated here in this embodiment.

In some embodiments, the wake-up signal is configured to trigger the user equipment to monitor the information data of the carrier monitored before sleep. The implementation process of the user equipment monitoring the information data of the carrier monitored before sleep can refer to the above-mentioned related embodiments, and it is not repeated here in this embodiment.

Through the above scheme, the information data is monitored on the carrier monitored by the user equipment before sleep, and the probability of successfully and timely receiving information data is higher, thereby further reducing the delay of the user equipment in sending and receiving data.

In some embodiments, the carrier indication information may include at least one carrier indication field, and the decimal value of the carrier indication field corresponds to a carrier index; or
the carrier indication information includes an index of a carrier combination; or
the carrier indication information includes a carrier index; or
the carrier indication information includes at least one carrier identification.

The explanation of the carrier indication information can refer to the above-mentioned related embodiments, and it is not limited here in this embodiment.

In some embodiments, the first duration is configured by the network device to the user equipment, or the first duration is reported by the user equipment to the network device.

In some embodiments, the information data may be one or more of downlink control information, downlink data information, uplink control information, uplink data information and a wake-up signal. For downlink control information, downlink data information, uplink control information, uplink data information and a wake-up signal, reference may be made to the above-mentioned related embodiments, and it is not repeated here in this embodiment.

FIG. 14 is a flowchart of a carrier monitoring method according to an example embodiment. The carrier monitoring method may be performed by the above-mentioned communication system. Referring to FIG. 14, the carrier monitoring method may include the following steps:

S1401, the network device sends a wake-up signal.

S1402, the user equipment receives the wake-up signal.

S1403, the user equipment monitors a target carrier.

For the implementation process of S1401, S1402 and S1403, reference may be made to the above-mentioned related embodiments, and it is not repeated here in this embodiment.

Through the above method, the network device sends a wake-up signal to wake up the main radio or change the sleep state of the main radio, and triggers the user equipment to monitor the target carrier, thereby monitoring the specific carrier, ensuring that the user equipment can send and receive data in a timely manner and avoiding unnecessary power consumption, and thus the delay and power consumption of the user equipment in sending and receiving data is reduced.

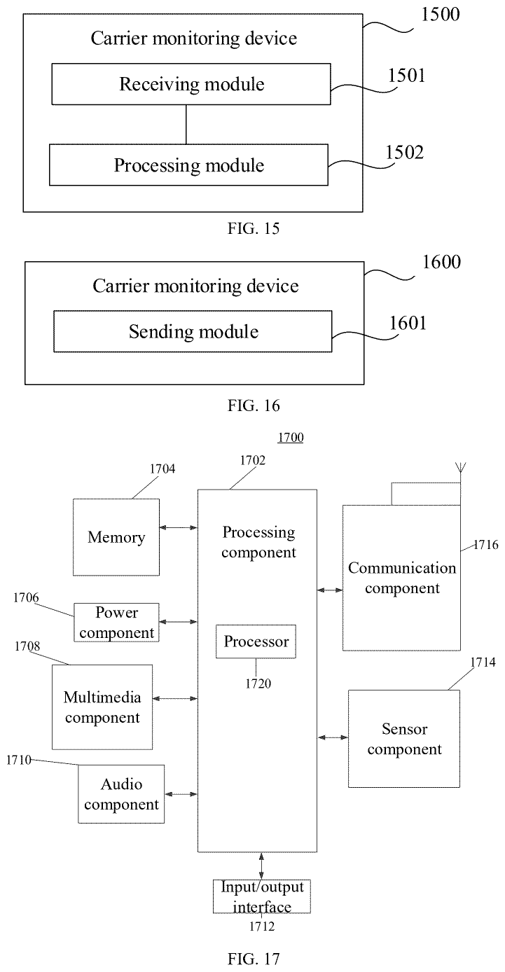

FIG. 15 is a block diagram of a carrier monitoring device according to an example embodiment. Referring to FIG. 15, the carrier monitoring device 1500 may include:
a receiving module 1501, configured to receive a wake-up signal; and
a processing module 1502, configured to monitor a target carrier.

In some embodiments, the processing module 1502 is specifically configured to monitor information data of the target carrier.

In some embodiments, the carrier monitoring device 1500 further includes:
a wake-up module, configured to wake up a main radio or change a sleep state of the main radio, where the main radio includes a main receiver and/or a main transceiver.

In some embodiments, the wake-up signal includes carrier indication information, and the processing module 1502 is specifically configured to monitor information data on the carrier indicated by the carrier indication information.

In some embodiments, the processing module 1502 is specifically configured to monitor information data on the carrier receiving the wake-up signal.

In some embodiments, the processing module 1502 is specifically configured to monitor information data on all carriers configured for the user equipment.

In some embodiments, the processing module 1502 is specifically configured to monitor information data on the carrier monitored by the user equipment before sleep.

In some embodiments, the processing module 1502 is specifically configured to monitor information data on the first carrier configured for the user equipment, and the first carrier is at least one of the following:
an anchor carrier;
a primary cell carrier; and
a primary secondary cell carrier.

In some embodiments, the carrier indication information includes at least one carrier indication field, and the decimal value of the carrier indication field corresponds to a carrier index; or
the carrier indication information includes an index of a carrier combination; or
the carrier indication information includes a carrier index; or
the carrier indication information includes at least one carrier identification.

In some embodiments, the first carrier is configured by at least one of the following signaling:
a downlink control information signaling;
a media access control signaling;
a media access control control element signaling; and
a radio resource control signaling.

In some embodiments, the processing module 1502 is specifically configured to monitor the information data of the target carrier at a first time node.

In some embodiments, the processing module 1502 is specifically configured to monitor the information data of the target carrier after a first duration since the first time node.

In some embodiments, the first time node is at least one of the following:
a time node when the user equipment receives the wake-up signal;
a time node when the user equipment successfully decodes the received wake-up signal;
a time node when the main radio is awakened; and
a time node when the sleep state of the main radio changes.

In some embodiments, the first duration is configured by the network device to the user equipment; or
the first duration is predefined in the protocol; or
the first duration is set by the user equipment and reported to the network device.

In some embodiments, the information data is at least one of the following:
downlink control information;
downlink data information;
uplink control information;
uplink data information; and
a wake-up signal.

Regarding the device in the above embodiment, the specific manner in which each module performs the operation has been described in detail in the embodiment of the method, and will not be described in detail here.

FIG. 16 is a block diagram of a carrier monitoring device according to an example embodiment. Referring to FIG. 16, the carrier monitoring device 1600 may include:
a sending module 1601 configured to send a wake-up signal, where the wake-up signal is configured to trigger the user equipment to wake up a main radio or change a sleep state of the main radio, and monitor a target carrier.

In some embodiments, the wake-up signal includes carrier indication information, and the carrier indication information indicates the target carrier for the user equipment to monitor the information data.

In some embodiments, the wake-up signal is configured to trigger the user equipment to monitor the information data of the target carrier at a first time node.

In some embodiments, the wake-up signal is configured to trigger the user equipment to monitor the information data of the target carrier after a first duration since the first time node.

In some embodiments, the wake-up signal is configured to trigger the user equipment to monitor the information data of the carrier receiving the wake-up signal.

In some embodiments, the wake-up signal is configured to trigger the user equipment to monitor the information data of all carriers configured to the user equipment.

In some embodiments, the wake-up signal is configured to trigger the user equipment to monitor the information data of the first carrier, and the first carrier is at least one of the following:
an anchor carrier;
a primary cell carrier; and
a primary secondary cell carrier.

In some embodiments, the wake-up signal is configured to trigger the user equipment to monitor the information data of the carrier monitored before sleep.

In some embodiments, the carrier indication information includes at least one carrier indication field, and the decimal value of the carrier indication field corresponds to a carrier index; or
the carrier indication information includes an index of a carrier combination; or
the carrier indication information includes a carrier index; or
the carrier indication information includes at least one carrier identification.

In some embodiments, the first duration is configured by the network device to the user equipment, or the first duration is reported by the user equipment to the network device.

In some embodiments, the information data is at least one of the following:
downlink control information;
downlink data information;
uplink control information;
uplink data information; and
a wake-up signal.

Regarding the device in the above embodiment, the specific manner in which each module performs the operation has been described in detail in the embodiment of the method, and will not be elaborated here.

The embodiment of the present disclosure also provides a computer-readable storage medium, on which computer program instructions are stored, and the steps of the above carrier monitoring method are implemented when the computer program instructions are executed by a processor.

FIG. 17 is a block diagram of a communication device according to an example embodiment. The communication device may be the user equipment described above, and the communication device may be a mobile phone, a computer, a digital broadcast terminal, a messaging device, a game console, a tablet device, a medical device, a fitness device, a personal digital assistant, etc.

Referring to FIG. 17, the communication device 1700 may include one or more of the following components: a processing component 1702, a memory 1704, a power component 1706, a multimedia component 1708, an audio component 1710, an input/output interface 1712, a sensor component 1714, and a communication component 1716.

The processing component 1702 generally controls the overall operation of the communication device 1700, such as operations associated with display, phone calls, data communications, camera operations, and recording operations. The processing component 1702 may include one or more processors 1720 to execute instructions to complete all or part of the steps of the carrier monitoring method. In addition, the processing component 1702 may include one or more modules to facilitate interaction between the processing component 1702 and other components. For example, the processing component 1702 may include a multimedia module to facilitate interaction between the multimedia component 1708 and the processing component 1702.

The memory 1704 is configured to store various types of data to support operations on the communication device 1700. Examples of such data include instructions for any application or method operating on the communication device 1700, contact data, phone book data, messages, pictures, videos, etc. The memory 1704 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 1706 provides power to the various components of the communication device 1700. The power component 1706 may include a power management system, one or more power supplies, and other components associated with generating, managing and distributing power for the communication device 1700.

The multimedia component 1708 includes a screen that provides an output interface between the communication device 1700 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 1708 includes a front camera and/or a rear camera. When the communication device 1700 is in an operating mode, such as a shooting mode or a video mode, the front camera and/or the rear camera may receive external multimedia data. Each front camera and rear camera may be a fixed optical lens system or have a focal length and optical zoom capability.

The audio component 1710 is configured to output and/or input audio signals. For example, the audio component 1710 includes a microphone (MIC), which is configured to receive external audio signals when the communication device 1700 is in an operating mode, such as a call mode, a recording mode, and a voice recognition mode. The received audio signal can be further stored in the memory 1704 or sent via the communication component 1716. In some embodiments, the audio component 1710 also includes a speaker for outputting audio signals.

The input/output interface 1712 provides an interface between the processing component 1702 and the peripheral interface module. The peripheral interface module can be a keyboard, a click wheel, a button, etc. These buttons may include, but are not limited to: a home button, a volume button, a start button, and a lock button.

The sensor component 1714 includes one or more sensors for providing various aspects of status evaluation for the communication device 1700. For example, the sensor assembly 1714 can detect the on/off state of the communication device 1700, the relative positioning of components, such as the display and keypad of the device 1700. The sensor assembly 1714 can also detect the position change of the communication device 1700 or a component of the communication device 1700, the presence or absence of user contact with the communication device 1700, the orientation or acceleration/deceleration of the communication device 1700, and the temperature change of the communication device 1700. The sensor assembly 1714 can include a proximity sensor configured to detect the presence of a nearby object without any physical contact. The sensor assembly 1714 can also include a light sensor, such as a CMOS or CCD image sensor, for use in imaging applications. In some embodiments, the sensor assembly 1714 can also include an acceleration sensor, a gyroscope sensor, a magnetic sensor, a pressure sensor, or a temperature sensor.

The communication assembly 1716 is configured to facilitate wired or wireless communication between the communication device 1700 and other devices. The communication device 1700 can access a wireless network based on a communication standard, such as WiFi, 2G or 3G, or a combination thereof. In an example embodiment, the communication component 1716 receives a broadcast signal or broadcast related information from an external broadcast management system via a broadcast channel. In an example embodiment, the communication component 1716 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an example embodiment, the communication device 1700 can be implemented by one or more of an application-specific integrated circuits (ASIC), a digital signal processor (DSP), a digital signal processing device (DSPD), a programmable logic devices (PLD), a field programmable gate array (FPGA), a controller, a microcontroller, a microprocessor or other electronic components to implement the carrier monitoring method.

In an example embodiment, a non-transitory computer-readable storage medium including instructions is also provided, such as a memory 1704 including instructions, which can be executed by a processor 1720 of the communication device 1700 to complete the carrier monitoring method. For example, the non-transitory computer-readable storage medium can be a ROM, a random access memory (RAM), a CD-ROM, a tape, a floppy disk, an optical data storage device, etc.

In addition to being an independent user equipment, the above-mentioned communication device 1700 can also be a part of an independent user equipment. For example, in one embodiment, the device can be an integrated circuit (IC) or a chip, where the integrated circuit can be an IC or a collection of multiple ICs. The chip can include but is not limited to the following types: GPU (Graphics Processing Unit), CPU (Central Processing Unit), FPGA (Field Programmable Gate Array), DSP (Digital Signal Processor), ASIC (Application Specific Integrated Circuit), SOC (System on Chip, SoC), etc. The above-mentioned integrated circuit or chip can be configured to execute executable instructions (or codes) to implement the above-mentioned carrier monitoring method. The executable instructions can be stored in the integrated circuit or chip, or can be obtained from other devices or equipment. For example, the integrated circuit or chip includes a processor, a memory, and an interface for communicating with other devices. The executable instruction may be stored in the processor, and the above-mentioned carrier monitoring method is implemented when the executable instruction is executed by the processor; or, the integrated circuit or chip may receive the executable instruction through the interface and transmit it to the processor for execution, so as to implement the above-mentioned carrier monitoring method.

In another example embodiment, a computer program product is also provided, which includes a computer program executable by a programmable device, and the computer program has a code portion for executing the above-mentioned carrier monitoring method when executed by the programmable device.

In another example embodiment, a chip is also provided, including a processor and an interface. The processor is configured to read instructions to execute the above-mentioned carrier monitoring method.

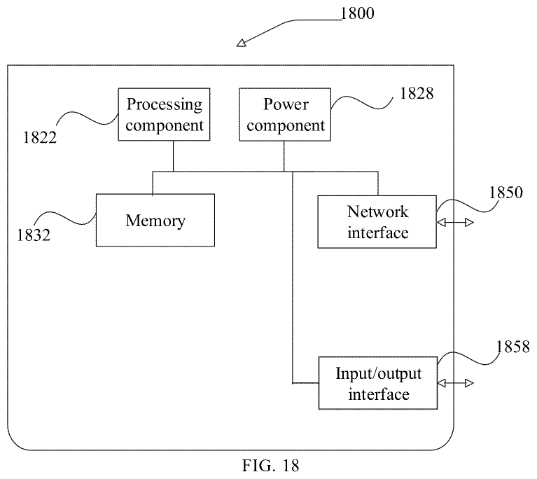

FIG. 18 is a block diagram of a communication device according to an example embodiment. The communication device 1800 can be the above-mentioned network device. Referring to FIG. 18, the communication device 1800 includes a processing component 1822, which further includes one or more processors, and a memory resource represented by a memory 1832 for storing instructions executable by the processing component 1822, such as an application. The application stored in the memory 1832 may include one or more modules each corresponding to a set of instructions. In addition, the processing component 1822 is configured to execute instructions to execute the above-mentioned carrier monitoring method.

The communication device 1800 may also include a power component 1828 configured to perform power management of the communication device 1800, a wired or wireless network interface 1850 configured to connect the communication device 1800 to the network, and an input/output interface 1858.

In an example embodiment, a non-transitory computer-readable storage medium including instructions is also provided, such as a memory 1832 including instructions, which can be executed by the processing component 1822 of the communication device 1800 to complete the above-mentioned carrier monitoring method. For example, the non-transitory computer-readable storage medium can be a ROM, a random access memory (RAM), a CD-ROM, a tape, a floppy disk, and an optical data storage device, etc.

After considering the specification and practicing the present disclosure, it will be easy for those skilled in the art to think of other embodiments of the present disclosure. This application is intended to cover any variation, use, or adaptive change of the present disclosure, which follows the general principles of the present disclosure and includes common knowledge or conventional technical means in the technical field that are not disclosed in the present disclosure. The description and embodiments are to be regarded as examples only, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the appended claims.

1. A carrier monitoring method, performed by a user equipment, comprising:
receiving a wake-up signal; and
monitoring a target carrier.

2. The method according to claim 1, wherein monitoring the target carrier comprises:
monitoring information data of the target carrier.

3. The method according to claim 1, further comprising:
waking up a main radio or changing a sleep state of the main radio, wherein the main radio comprises at least one of a main receiver or a main transceiver.

4. The method according to claim 3, wherein the wake-up signal comprises carrier indication information, and monitoring the target carrier comprises:
monitoring information data on a carrier indicated by the carrier indication information.

5. The method according to claim 3, wherein monitoring the target carrier comprises:
monitoring information data on a carrier receiving the wake-up signal.

6. The method according to claim 1, wherein monitoring the target carrier comprises:
monitoring information data on all carriers configured for the user equipment.

7. The method according to claim 1, wherein monitoring the target carrier comprises:
monitoring information data on a carrier monitored by the user equipment before sleep.

8. The method according to claim 1, wherein monitoring the target carrier comprises:
monitoring information data on a first carrier configured by the user equipment, wherein the first carrier is at least one of:
an anchor carrier;
a primary cell carrier; and
a primary secondary cell carrier.

9. The method according to claim 4, wherein the carrier indication information comprises;
at least one carrier indication field, a decimal value of the carrier indication field corresponds to a carrier index; or
an index of a carrier combination; or
a carrier index; or
at least one carrier identification.

10. The method according to claim 8, wherein the first carrier is configured by at least one of:
a downlink control information signaling;
a media access control signaling;
a media access control control element signaling; and
a radio resource control signaling.

11. The method according to claim 1, wherein monitoring the target carrier comprises:
monitoring information data of the target carrier at a first time node.

12. The method according to claim 1, wherein monitoring the target carrier comprises:
monitoring information data of the target carrier after a first duration since a first time node.

13. The method according to claim 11, wherein the first time node is at least one of:
a time node when the user equipment receives the wake-up signal;
a time node when the user equipment successfully decodes the received wake-up signal;
a time node when a main radio is awakened; and
a time node when a sleep state of the main radio changes.

14. The method according to claim 11, wherein the first duration is:
configured by a network device to the user equipment; or
predefined in a protocol; or
set by the user equipment and reported to a network device.

15. (canceled)

16. A carrier monitoring method, performed by a network device, comprising:
sending a wake-up signal, wherein the wake-up signal is configured to trigger a user equipment to wake up a main radio or change a sleep state of the main radio, and monitor a target carrier.

17.-28. (canceled)

29. A communication device, comprising:
a processor; and
a memory for storing processor executable instructions;
wherein the processor is configured to:
receive a wake-up signal; and
monitor a target carrier.

30. A non-transitory computer-readable storage medium storing computer program instructions that, when executed by a processor, cause the processor to perform the method according to claim 1.

31. A communication system, comprising:
a user equipment, configured to receive a wake-up signal and monitor a target carrier; and
a network device, configured to execute the method according to claim 16.

32. A communication device, comprising:
a processor; and
a memory for storing processor executable instructions;
wherein the processor is configured to perform the method according to claim 16.

33. A non-transitory computer-readable storage medium storing computer program instructions that, when executed by a processor, cause the processor to perform the method according to claim 16.
